(19) United States
(12) Patent Application Publication
(10) Pub. No.: US 2015/0252200 A1
(43) Pub. Date: Sep. 10, 2015

(54) INK COMPOSITION AND RECORDING APPARATUS

(71) Applicant: SEIKO EPSON CORPORATION, Tokyo (JP)

(72) Inventors: Takayoshi KAGATA, Shiojiri (JP); Masahiro YATAKE, Shiojiri (JP); Hiroshi MUKAI, Shiojiri (JP); Masashi KAMIBAYASHI, Matsumoto (JP)

(21) Appl. No.: 14/641,802

(22) Filed: Mar. 9, 2015

(30) Foreign Application Priority Data
Mar. 10, 2014 (JP) 2014-046869

(51) Int. Cl. C09D 11/106; C09D 125/14

(52) U.S. Cl. CPC C09D 11/106; C09D 125/14

(57) ABSTRACT

An ink composition includes: a color material; water; and a polymer particle, in which the polymer particle has a core-shell structure including a core polymer and a shell polymer, in which the core polymer has a glass transition temperature of lower than 60° C., and the shell polymer has a glass transition temperature of higher than or equal to 60° C., in which the polymer particle has an acid value of greater than or equal to 50 mgKOH/g, and in which the shell polymer includes an aromatic monomer as a constitutional unit.

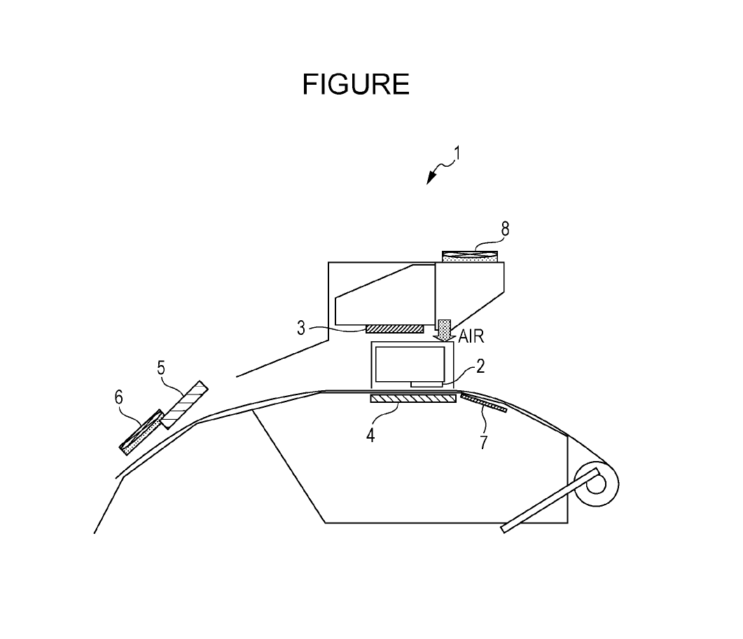

### BACKGROUND

1. Technical Field

The present invention relates to an ink composition and a recording apparatus.

2. Related Art

A resin emulsion in the related art is a core-shell type resin emulsion. A study on a core-shell type resin emulsion having a structure in which a core part is made of a thermoplastic resin and a shell part is made of a resin having a three-dimensional crosslinked structure has been conducted so that the storage stability of a recorded image is excellent, if necessary, the recorded image can be easily erased from a recording medium, and the recording medium can be suitably repeatedly used (JP-A-2002-12802). In addition, a study on a core-shell type resin emulsion having a structure in which a core made of an acryl-based resin is covered with a polycarbonate-based urethane resin shell has been conducted in order to obtain an ink having excellent ejection stability and storage stability and excellent image toughness such as marker resistance, abrasion resistance, or the like (JP-A-2012-25947). Further, a study on a resin emulsion having a core-shell structure in which an outer layer is made of a urethane resin and an inner layer is made of an acrylic resin has been conducted in order to obtain an ink capable of being printed even on an ink non-absorptive material such as plastic, metal, or the like and having excellent adhesivity, film forming properties, and chemical resistance (JP-A-2012-92224). Furthermore, a study on a tri-block polymer, although different from a core-shell type resin emulsion, has been conducted in order to provide an aqueous ink for an ink jet having excellent storage stability and ejection stability and high abrasion resistance of an image (JP-A-2012-72354).

However, in the ink disclosed in JP-A-2002-12802, friction resistance cannot be obtained because the shell part has a crosslinked structure, and in the ink disclosed in JP-A-2012-25947, it is difficult to improve friction resistance and obtain clogging recovery properties because the shell part is made of a polycarbonate-based urethane resin. Even in the ink disclosed in JP-A-2012-92224, it is difficult to improve friction resistance and obtain clogging recovery properties because the shell part is made of urethane. Moreover, since the ink disclosed in JPA-2012-72354 has a tri-block structure, ejection stability is obtained selectively, but it is difficult to obtain clogging recovery properties.

### SUMMARY

An advantage of some aspects of the invention is to provide an ink composition which has excellent friction resistance, and ejection stability improved by suppressing short-term and long-term clogging, and a recording apparatus.

The present inventors have conducted intensive studies. As a result, the invention has been completed by defining the glass transition temperature and acid value of a monomer or a core-shell.

According to an aspect of the invention, there is provided an ink composition, including: a color material; water; and a polymer particle, in which the polymer particle has a core-shell structure including a core polymer and a shell polymer, the core polymer has a glass transition temperature of lower than 60° C., the shell polymer has a glass transition temperature of higher than or equal to 60° C., the polymer particle has an acid value of greater than or equal to 50 mgKOH/g, and the shell polymer includes an aromatic monomer as a constitutional unit.

According to the ink composition of the aspect of the invention, by setting the glass transition temperature of the core polymer to be lower than 60° C., the core polymer can be easily discharged after the shell polymer is softened, and thus there is a tendency of the ink composition to have more excellent adhesivity.

In addition, by setting the glass transition temperature of the shell polymer to be higher than or equal to 60° C., when the ink composition is ejected under a high-temperature environment, it is possible to eject the polymer particles from a recording head without disrupting a core-shell type structure, and it is possible to further suppress the deposition of the polymer particles in nozzles, so that the clogging of nozzles can be prevented, and the stability of the ink composition in intermittent printing tends to become more excellent. When a film is formed on the recording medium, the ink composition on the recording medium is heated to a temperature higher than the glass transition temperature of the shell polymer, and thus the core polymer is discharged from the softened shell polymer, thereby forming a film on the recording medium by the core polymer and the shell polymer. At this time, the softened core polymer spreads and adheres onto the recording medium, thereby forming a film having excellent fixability.

Further, by setting the acid value of the polymer particle to be greater than or equal to 50 mgKOH/g, it is possible to improve the re-dispersibiity in water, and thus clogging recovery properties are excellent, and long-term nozzle clogging can be prevented.

Moreover, when the shell polymer includes an aromatic monomer as a constitutional unit, a detailed action mechanism is unknown, but ejection bending is prevented. In particular, in the case of small dots, ink droplets easily bend, and thus, according to the aspect of the invention, ejection bending is suppressed. By including a relatively stiff aromatic monomer, it is possible to improve the water friction resistance (wet friction) of a film formed on a recording medium.

Preferably, the ink composition of the aspect of the invention is recorded on the heated recording medium. Particularly, even when recording is performed in a heated state, the ejection stability of the ink composition can be improved, and simultaneously the printing durability of the recorded image can be improved.

Preferably, the core polymer includes an aromatic monomer as a constitutional unit, and the core polymer does not have an acid value. Thus, the core polymer can form a hydrophobic film, thereby improving the friction resistance, more specifically, water friction resistance of the recorded image.

Preferably, the polymer particle is synthesized without substantially using an emulsifier. Here, the “emulsifier” means a surfactant used in synthesis. The ink composition containing the polymer particles synthesized using such an emulsifier is problematic in that foaming easily occurs, the gloss of an image hardly appears, and foreign matter is easily generated. According to the aspect of the invention, the ink composition for overcoming the above problem is obtained.

Preferably, the polymer particle includes an aromatic monomer in an amount of greater than or equal to 10 mass % and less than or equal to 80 mass % as a constitutional unit. Thus, it is possible to improve water friction resistance (wet friction).

Preferably, the ink composition of the aspect of the invention includes a wax particle having a melting point of higher than or equal to 70° C. and lower than or equal to 110° C. When a recording head is heated, there is a possibility that polymer particles are aggregated and deposited with the evaporation of moisture to cause clogging in nozzles of the recording head, thereby inhibiting the stable ejection of the ink composition. In contrast, when the wax particles having the above-mentioned melting point are used in combination therewith, the aggregation of the polymer particles is suppressed during the evaporation of moisture. Therefore, ejection failure and clogging caused by the deposition of polymer particles to nozzles of the recording head can be suppressed, and thus the ink composition has excellent recording stability. Further, at the time of high-temperature recording, the wax particles prevent a film from becoming too brittle by the polymer particles. Therefore, the friction resistance of the ink composition hardly deteriorates even when recording is performed at a high temperature.

Preferably, the ink composition of the aspect of the invention includes an alkyl polyol having a normal boiling point of higher than or equal to 160° C. and lower than or equal to 260° C. and a Hansen solubility parameter (SP) value of greater than or equal to 10 (cal/cm³)^{1/2} and less than or equal to 15 (cal/cm³)^{1/2}. Thus, the compatibility with the core shell can be improved, and short-term clogging can be suppressed, thereby improving intermittent characteristics.

Preferably, the average particle diameter of the polymer particle is greater than or equal to 10 nm and less than or equal to 100 nm. Thus, it is difficult to form a large lump even when the polymer particles are aggregated, and thus it is possible to suppress the clogging of nozzles.

Preferably, the shell polymer further includes a carboxylic acid monomer as a constitutional unit, and the ratio of the aromatic monomer to the carboxylic acid monomer (aromatic monomer/carboxylic acid monomer) is greater than or equal to 0.15. Thus, it is possible to obtain an ink composition excellent in the balance of the improvement of friction resistance due to the aromatic monomer and the improvement of re-dispersibility due to the carboxylic acid monomer.

According to another aspect of the invention, there is provided a recording apparatus, including: the above-described ink composition; and an ejection head for ejecting this ink composition.

For example, the ejection head includes nozzles for ejecting the ink composition, and dots of the ink composition can be ejected in a multi-size from one of the nozzles.

### BRIEF DESCRIPTION OF DRAWING

The invention will be described with reference to the accompanying drawing, wherein like numbers reference like elements.

FIGURE is a schematic view showing a schematic configuration of an ink jet recording apparatus according to the present embodiment.

### DESCRIPTION OF EXEMPLARY EMBODIMENTS

Hereinafter, preferred embodiments of the invention will be described in detail. However, the invention is not limited to the following embodiments. Various modifications can be made within the scope not departing from the gist thereof.

### Ink Composition

The ink composition according to the present embodiment includes: a color material; water; and a polymer particle, in which the polymer particle has a core-shell structure including a core polymer and a shell polymer, the core polymer has a glass transition temperature of lower than 60° C., the shell polymer has a glass transition temperature of higher than or equal to 60° C., the polymer particle has an acid value of greater than or equal to 50 mgKOH/g, and the shell polymer includes an aromatic monomer as a constitutional unit.

### Color Material

The color material is selected from pigments and dyes.

### Pigment

In the present embodiment, when a pigment is used as the color material, it is possible to improve the light resistance of ink. As the pigment, any one of inorganic pigments and organic pigments may be used.

The inorganic pigment is not particularly limited, but examples thereof include carbon black, iron oxide, titanium oxide, and silica oxide. These inorganic pigments may be used alone or in a combination of two or more thereof.

The organic pigment is not particularly limited, but examples thereof include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments. Specific examples of the organic pigment are exemplified as follows.

The pigment used in black ink is not particularly limited, but an example thereof includes carbon black. Carbon black is not particularly limited, but examples thereof include furnace black, lamp black, acetylene black, and channel black (C.I. Pigment Black 7). Further, the commercially available product of carbon black is not particularly limited, but examples thereof include No. 2300, No. 900, MCF88, No. 20B, No. 33, No. 40, No. 45, No. 52, MA7, MA8, MA100, and No. 2200B (all are trade names, manufactured by Mitsubishi Chemical Corporation); Color Black FW1, Color Black FW2, Color Black FW2V, Color Black FW18, Color Black FW200, Color Black 5150, Color Black 5160, Color Black 5170, Pritex 35, Pritex U, Pritex V, Pritex 140U, Special Black 6, Special Black 5, Special Black 4A, Special Black 4, Special Black 250, or the like (all are trade names, manufactured by Degussa AG); Conductex SC, Raven 5750, Raven 5250, Raven 5000, Raven 3500, Raven 1255, Raven 700, or the like (all are trade names, manufactured by Columbian Carbon Japan Ltd.); and Regal 400R, Regal 330R, Regal 660R, Mogul L, Monarch 700, Monarch 800, Monarch 880, Monarch 900, Monarch 1000, Monarch 1100, Monarch 1300, Monarch 1400, Elftex 12 or the like (all are trade names, manufactured by CABOT Corporation).

Examples of the pigment used in cyan ink include C.I. Pigment Blues 1, 2, 3, 15, 15:1, 15:2, 15:3, 15:4, 15:6, 15:34, 16, 18, 22, 60, 65, and 66; and C.I. Bat Blues 4 and 60. Among these, at least one of C.I. Pigment Blues 15:3 and 15:4 is preferable.

Examples of the pigment used in magenta ink include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:2, 48:4, 57, 57:1, 88, 112, 114, 122, 123, 144, 146, 149, 150, 166, 168, 170, 171, 175, 176, 177, 178, 179, 184, 185, 187, 202, 209, 219, 224, 245, 254, and 264; and C.I. Pigment Violets 19, 23, 32, 33, 36, 38, 43, and 50. Among these, one or more selected from the group consisting of C.I. Pigment Red 122, C.I. Pigment Red 202, and C.I. Pigment Violet 19 is preferable.

Examples of the pigment used in yellow ink include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, 180, 185, and 213. Among these, one or more selected from the group consisting of C.I. Pigment Yellows 74, 155, and 213 is preferable.

Examples of the pigment used in white ink include, but are not particularly limited to, C.I. Pigment Whites 6, 18, and 21, titanium oxide, zinc oxide, zinc sulfide, antimony oxide, zirconium oxide, white hollow resin particles, and polymer particles.

In addition, as the pigments used in color inks such as green ink, orange ink and the like, except for the above colors, commonly known pigments are used.

### Dye

In the present embodiment, a dye can be used as the color material. The dye is not particularly limited, but examples thereof include acidic dyes, direct dyes, reactive dyes, and basic dyes.

The content of the color material is preferably 0.4 mass % to 12 mass %, and more preferably 2 mass % to 5 mass %, based on the total mass (100 mass %) of ink.

### Water

The ink composition according to the present embodiment includes water. Examples of water include pure water, such as ion exchange water, ultrafiltered water, reverse osmosis water, and distilled water; and ultrapure water which is obtained by completely removing ionic impurities as much as possible. In addition, when water sterilized by ultraviolet irradiation or addition of hydrogen peroxide is used, it is possible to prevent the occurrence of mold and bacteria in the case where a pigment dispersion liquid and an ink using the same are stored for a long period of time.

The content of water is not particularly limited, and may be appropriately determined as necessary.

### Polymer Particle

As described above, the polymer particle has a core-shell structure including a core polymer and a shell polymer. Here, the core polymer has a glass transition temperature of lower than 60° C., and the shell polymer has a glass transition temperature of higher than or equal to 60° C. Further, the polymer particle has an acid value of greater than or equal to 50 mgKOH/g, and the shell polymer includes an aromatic monomer as a constitutional unit.

The core-shell structure refers to a structure in which a core polymer is formed in the void of a shell polymer. Therefore, the core-shell structure includes not only a structure in which the surface of the core polymer is covered with the shell polymer, but also a structure in which a part of the void of a three-dimensional network structure caused by the shell polymer is filled with the core polymer. Accordingly, the core-shell structure in the present specification includes a structure of a polymer particle in which the boundary between the core part and the shell part are not exactly clear.

### Core Polymer

The glass transition temperature of the core polymer is lower than 60° C., and preferably higher than or equal to 0° C. and lower than 60° C. When the glass transition temperature of the core polymer is lower than 60° C., the core polymer can be easily discharged after the shell polymer is softened, and thus the ink composition has more excellent adhesivity. In addition, when the glass transition temperature of the core polymer is higher than or equal to 0° C., the storage stability of the ink composition is excellent.

Glass transition temperature (hereinafter, referred to as “Tg”) is calculated by using an analysis method such as viscoelasticity measurement, thermal analysis or the like, or by using a calculation formula based on Tg of homopolymer of commonly known polymerizable monomers. When the resin included in the core polymer and the following shell polymer is a copolymer, the glass transition temperature (Tg) of the copolymer can be calculated by the following FOX Equation based on Tgₙ (unit: K) of hompolymer and mass fraction (Wₙ) of monomer.

$$\frac{I}{Tg} = \frac{{W}_{1}}{{Tg}_{1}} + \frac{{W}_{2}}{{Tg}_{2}} + … + \frac{{W}_{n}}{{Tg}_{n}}$$

Here, Wₙ: mass fraction of each monomer, Tgₙ: Tg of homopolymer of each monomer (unit: K), and Tg: Tg of copolymer (unit: K).

In other words, when a polymer is a homopolymer, the glass transition temperature of the core polymer or the shell polymer can be controlled by selecting the homopolymer. In addition, when a polymer is a copolymer, the glass transition temperature thereof can be controlled by considering Tg of the above homopolymer and the above FOX Equation.

The core polymer is designed to be a highly hydrophobic polymer. Therefore, it is preferable that the core polymer does not have an acid value. In addition, it is preferable that the core polymer includes at least an aromatic monomer as a constitutional unit. Therefore, the core polymer becomes hydrophobic, and thus a hydrophobic film can be formed. As a result, it is possible to improve water friction resistance that is one of the friction resistances of a recorded image.

In addition, examples of the constitutional unit of the core polymer include, but are not limited to, a hydrophilic (meth)acrylate monomer, a hydrophobic (meth)acrylate monomer having an alkyl group of 3 or more carbon atoms, a hydrophobic (meth)acrylate monomer having a cyclic structure, a (meth)acrylamide monomer or an N-substituted derivative thereof, and a carboxylic acid monomer.

The aromatic monomer is not particularly limited, but examples thereof include styrene, α-methyl styrene, p-methyl styrene, vinyl toluene, chlorostyrene, and divinyl benzene.

The hydrophilic (meth)acrylate monomer is not particularly limited, but examples thereof include methyl (meth)acrylate, ethyl (meth)acrylate, α-hydroxymethyl (meth) acrylate, 2-hydroxyethyl (meth) acrylate, (poly)ethyleneglycol (meth) acrylate, methoxy(poly)ethylene glycol (meth) acrylate, ethoxy(poly)ethyleneglycol (meth) acrylate, and (poly) propyleneglycol (meth) acrylate.

Among these, methyl (meth)acrylate and ethyl (meth)acrylate are preferable. Here, the “hydrophilicity” means that the solubility in 100 mL of water (20° C.) is more than or equal to 0.3 g.

Examples of the hydrophobic (meth)acrylate monomer having an alkyl group of 3 or more carbon atoms include, but are not limited to, (meth)acrylates having an alkyl group of or more carbon atoms, such as n-propyl (meth)acrylate, isopropyl (meth)acrylate, n-butyl (meth)acrylate, isobutyl (meth)acrylate, n-amyl (meth)acrylate, isoamyl (meth)acrylate, hexyl (meth)acrylate, 2-ethylhexyl (meth)acrylate, n-octyl (meth)acrylate, nonyl (meth)acrylate, decyl (meth)acrylate, lauryl (meth)acrylate, stearyl (meth) acrylate, cetyl (meth) acrylate, neopentyl (meth)acrylate, behenyl (meth) acrylate, and the like. Among these, lauryl (meth)acrylate is preferable. Here, the “hydrophobicity” means that the solubility in 100 mL of water (20° C.) is less than 0.3 g.

Examples of the hydrophobic (meth)acrylate monomer having a cyclic structure include, but are not limited to, cyclohexyl (meth) acrylate, dicyclopentanyl (meth) acrylate, dicyclopentenyl (meth) acrylate, dicyclopentenyloxyethyl (meth) acrylate, isobornyl (meth) acrylate, norbornyl (meth)acrylate, adamantyl (meth)acrylate, and tetrahydrofurfuryl (meth) acrylate.

Examples of the (meth)acrylamide monomer or the N-substituted derivative thereof include, but are not limited to, (meth)acrylamides or N-substituted derivatives thereof, such as (meth)acrylamide, N-hydroxymethyl (meth)acrylamide, diacetone acrylamide, N,N-dimethyl acryl(meth)amide, and the like.

Examples of the carboxylic acid monomer include, but are not limited to, (meth)acrylic acid, crotonic acid, maleic acid, fumaric acid, and itaconic acid. Among these, (meth)acrylic acid is preferable. Here, the “carboxylic acid monomer unit” refers to a polymerizable monomer unit having a carboxyl group and a polymerizable unsaturated group.

The above monomers may be used alone or in a combination of two or more thereof.

Among all the repeating units constituting the resin contained in the core polymer, the content of the repeating unit derived from the hydrophobic monomer is preferably more than or equal to 60 mass %, more preferably more than or equal to 75 mass %, and still more preferably more than or equal to 90 mass %. When the content of the repeating unit derived from the hydrophobic monomer is within the above range, a hydrophobic film is formed on the surface of an image recorded on a recording medium by performing heat treatment or the like, and thus the friction resistance of the image tends to be further improved.

### Shell Polymer

The glass transition temperature of the shell polymer is higher than or equal to 60° C., and preferably higher than or equal to 60° C. and lower than or equal to 150° C. When the glass transition temperature of the shell polymer is higher than or equal to 60° C., in the case where the ink composition is ejected under a high-temperature environment, it is possible to eject the polymer particles from a recording head without disrupting a core-shell type structure, and it is possible to further suppress the deposition of the polymer particles in nozzles, so that the clogging of nozzles can be prevented, and the stability of the ink composition in intermittent printing tends to become more excellent. In the case where a film is formed on the recording medium, the ink composition on the recording medium is heated to a temperature higher than the glass transition temperature of the shell polymer, and thus the core polymer flows out from the shell polymer, thereby forming a film on the recording medium by the core polymer and the shell polymer. At this time, the softened core polymer spreads and adheres onto the recording medium, thereby forming a film having excellent fixability. Further, when the glass transition temperature of the shell polymer is lower than or equal to 150° C., the shell polymer on the recording medium is easily softened, and thus the adhesivity of the ink composition tends to become excellent. Meanwhile, when the glass transition temperature of the shell polymer is higher than 150° C., the thermal deformation properties of the emulsion type resin become poor, thus having a negative influence such as thickening or the like on the system.

Since the shell polymer is hydrophilic, it has an acid value. Preferably, the acid value of the shell polymer is 20 mgKOH/g to 120 mgKOH/g. When the acid value thereof is within the above range, sufficient hydrophilicity necessary for the shell polymer can be secured.

The shell polymer contains an aromatic monomer as a constitutional unit. When the shell polymer contains an aromatic monomer as a constitutional unit, a detailed action mechanism is unknown, but the ejection bending is prevented. In particular, in the case of small dots, ink droplets easily bend, and thus ejection bending is suppressed according to an aspect of the invention. Therefore, the ink composition according to an aspect of the invention is particularly suitable for a head that can eject ink dots in a multi-size from one nozzle. In addition, the shell polymer contains a relatively stiff aromatic monomer, thereby improving the water friction resistance (wet friction) of a film formed on the recording medium.

In addition, it is preferable that the shell polymer contains a (meth)acrylate monomer and a carboxylic acid monomer as a constitutional unit. When such a resin is used, it is possible to provide a carboxyl group on the surface of the shell polymer. Therefore, the dispersion stability of the polymer particles is further improved, and the viscosity of the ink composition becomes relatively low, and thus ejection stability tends to be further improved. The (meth)acrylate monomer is not particularly limited, but examples thereof include a hydrophilic (meth)acrylate monomer, a hydrophobic (meth)acrylate monomer having an alkyl group of 3 or more carbon atoms, and a hydrophobic (meth)acrylate monomer having a cyclic structure. Specific examples of the (meth)acrylate monomer and the carboxylic acid monomer are the same as those of the above-mentioned monomers constituting the resin contained in the core polymer. These monomers may be used alone or in a combination of two or more thereof.

In the shell polymer, the ratio of the aromatic monomer to the carboxylic acid monomer (aromatic monomer/carboxylic acid monomer) is preferably more than or equal to 0.15, and more preferably ˜. Thus, it is possible to obtain an ink composition excellent in the balance of the improvement of friction resistance due to the aromatic monomer and the improvement of re-dispersibility due to the carboxylic acid monomer.

Among all the repeating units constituting the resin contained in the shell polymer, the content of the repeating units derived from the (meth)acrylic acid ester and the unsaturated carboxylic acid is preferably more than or equal to 20 mass %, more preferably more than or equal to 30 mass %, and still more preferably more than or equal to 35 mass %.

Among all the repeating units constituting the resin contained in the shell polymer, the content of the repeating unit derived from the hydrophilic monomer is preferably more than or equal to 20 mass %, more preferably more than or equal to 30 mass %, and still more preferably more than or equal to 35 mass %. When the content of the repeating unit derived from the hydrophilic monomer is within the above range, since the shell polymer has hydration properties, the dispersion stability of the polymer particles in the ink composition tends to be improved. In addition, since the shell polymer can more effectively suppress the deposition of the polymer particles to a nozzle, the ejection stability of the ink composition from the nozzle of a recording head tends to be better.

Meanwhile, among all the repeating units constituting the resin contained in the shell polymer, the content of the repeating unit derived from the hydrophobic monomer is preferably more than or equal to 10 mass %, more preferably more than or equal to 20 mass %, and still more preferably more than or equal to 30 mass %. By setting the content of the repeating unit derived from the hydrophobic monomer to be within the above range, even when the occupancy rate of an organic solvent is increased due to the drying of water in the recording head and on the recording medium, the dispersion of the polymer particles is stable, and the aggregation of the polymer particles can be suppressed.

### Entire Polymer Particles

Preferably, the polymer particle, including both the core polymer and the shell polymer, contains an aromatic monomer in an amount of greater than or equal to 10 mass % and less than or equal to 80 mass % (based on the total mass of the polymer particles) as a constitutional unit. When the polymer particle contains a relatively stiff aromatic monomer in an amount of greater than or equal to 10 mass % and less than or equal to 80 mass %, the water friction resistance (wet friction) of a film formed on the recording medium can be improved.

As described above, the polymer particles are prepared such that the acid value thereof is greater than or equal to 50 mgKOH/g. When the acid value of the polymer particles is greater than or equal to 50 mgKOH/g, the re-dispersibility of the polymer particles in water can be improved, and thus excellent clogging recovery properties are exhibited, and long-term nozzle clogging prevention performance (clogging recovery properties) is improved.

The average particle diameter of the polymer particles is preferably more than or equal to 10 nm and less than or equal to 100 nm. As such, when the average particle diameter of the polymer particles is relatively small, the ink composition is characterized in that the gloss of the recorded image easily appears, and excellent film forming properties are exhibited. In addition, when the average particle diameter of the polymer particles is relatively small, a large lump is hardly formed even when the polymer particles are aggregated, and thus it is possible to suppress the clogging of nozzles. Further, when the average particle diameter of the polymer particles is small, the viscosity of the ink composition can be increased to be relatively high, and thus it is possible to prevent the viscosity of the ink composition from being lowered to such a degree that ink ejection properties becomes unstable, even when the temperature of the ink composition rises in the recording head.

Moreover, in the present specification, the average particle diameter is based on volume unless otherwise specified. For example, the average particle diameter may be measured by a particle size distribution analyzer using a laser diffraction scattering method as a measurement principle. An example of the particle size distribution analyzer includes a particle size distribution meter (for example, Microtrac UPA, manufactured by Nikkiso Co., Ltd.) using a dynamic light scattering method as a measurement principle.

In the ratio of the mass of the core polymer to the mass of the shell polymer in the polymer particle, preferably the mass of the core polymer≦the mass of the shell polymer, and more preferably the mass of the core polymer<the mass of the shell polymer. Still more preferably, the mass of the core polymer is 40% to 80% when the mass of the shell polymer is 100%. For this reason, the balance between the mass of the core polymer and the mass of the shell polymer becomes good, so that the fixability of the ink composition is good, the ejection stability of the ink composition is excellent, and vertical misalignment tends to hardly occur. The vertical misalignment refers to a phenomenon in which, in the continuous ejection of ink, ink is partially solidified around a nozzle by long-term ejection, and thus clear vertical lines cannot be printed due to a curved ejection direction.

The content (based on solid) of the polymer particles in the ink composition is preferably more than or equal to 0.5 mass % and less than or equal to 20 mass %, more preferably more than or equal to 0.6 mass % and less than or equal to 15 mass %, and still more preferably more than or equal to 0.7 mass % and less than or equal to 10 mass %, based on the total mass (100 mass %) of the ink composition. When the content of the polymer particles is more than or equal to 0.5 mass %, the friction resistance and adhesivity of the ink composition tend to be more excellent. When the content of the polymer particles is less than or equal to 20 mass %, the ejection stability of the ink composition tends to be more excellent.

### Method of Forming Polymer Particles

There is no limitation to the formation method of the above-mentioned polymer particles, but preferably, the polymer particles are formed by soap-free polymerization without substantially using an emulsifier. The soap-free polymerization refers to a polymerization process for forming a core-shell polymer without substantially using an emulsifier. Here, the “emulsifier” means a surfactant used in synthesis. Further, an example of the soap-free polymerization includes a process of polymerizing polymer particles under the condition of the content of an emulsifier in a solution being less than or equal to 1 mass %. In the related art, the ink composition containing the polymer particles synthesized using such an emulsifier is problematic in that foaming easily occurs, the gloss of an image is difficult to appear, and foreign matter is easily generated. According to an aspect of the invention, an ink composition that suppresses the occurrence of such problems can be obtained. In the soap-free polymerization, for example, a shell polymer containing (meth)acrylic acid as a constitutional unit is formed, and a core polymer is formed in the shell polymer. Moreover, when polymer particles are formed using soap-free polymerization, the average particle diameter of the polymer particles becomes very small, and the ejection stability and glossiness of an ink composition are improved.

The surfactant used in synthesis is not particularly limited, but an anionic surfactant and a nonionic surfactant are preferable. Examples of the anionic surfactant include sodium dodecylbenzene sulfonate, sodium laurate, and ammonium salts of polyoxyethylene alkyl ether sulfate. Examples of the nonionic surfactant include polyoxyethylene alkyl ethers, polyoxyethylene alkyl esters, polyoxyethylene sorbitan fatty acid esters, polyoxyethylene alkyl phenyl ethers, polyoxyethylene alkyl amines, and polyoxyethylene alkyl amides. The core-shell polymer used in the present embodiment is prepared without using these surfactants.

The polymerization initiator used in the soap-free polymerization is not particularly limited, but is preferably a hydrophilic polymerization initiator. Examples thereof include potassium persulfate, ammonium persulfate, hydrogen peroxide, and the like.

An example of the soap-free polymerization method will be described, but a synthesis method is not limited to the following method. For example, ion exchange water and a polymerization initiator are put into a polymerization reactor provided with a jacket, and the pressure in the polymerization reactor is reduced to remove oxygen, and then the pressure therein is set to atmospheric pressure with nitrogen to make a nitrogen atmosphere. First, under the nitrogen atmosphere, the temperature in the polymerization reactor is set to a predetermined temperature, and then a pre-emulsion solution containing monomers (to become a constituent of a shell polymer) is dropped by a predetermined amount to perform a polymerization reaction to thus synthesize a shell polymer. Next, a core polymer is obtained by polymerizing the monomers using the void of the obtained shell polymer as a polymerization field, thereby synthesizing the polymer particles according to the present embodiment. Specifically, a monomer mixture containing the above-mentioned hydrophobic monomers is dropped into an aqueous dispersion medium containing a shell polymer to obtain a core polymer by polymerization, and the obtained core polymer is formed into polymer particles. As such, when a shell polymer is used as the polymerization field of a core polymer, there is no need to use an emulsifier in the monomer mixture.

According to such a soap-free polymerization, the content of an emulsifier in the ink composition can be easily set to be less than or equal to 0.01 mass %, and the average particle diameter of the polymer particles can also be adjusted to be very small.

### Wax Particle

The ink composition of the present embodiment includes wax particles having a melting point of higher than or equal to 70° C. and lower than 110° C. When a recording head is heated, there is a possibility that polymer particles are aggregated and deposited with the evaporation of moisture to cause clogging in the nozzles of the recording head, thereby inhibiting the stable ejection of the ink composition. In contrast, when the wax particles having the above-mentioned melting point are used in combination therewith, the aggregation of the polymer particles is suppressed during the evaporation of moisture. Therefore, ejection failure and clogging caused by the deposition of polymer particles to the nozzles of the recording head can be suppressed, and thus the ink composition has excellent recording stability. Further, at the time of high-temperature recording, the wax particles prevent a film from becoming too brittle by the polymer particles. Therefore, the friction resistance of the ink composition hardly deteriorates even when recording is performed at a high temperature.

The melting point of the wax particles is higher than or equal to 70° C. and lower than 110° C., and more preferably higher than or equal to 80° C. and lower than or equal to 110° C. When the melting point thereof is within the above range, it is possible to obtain recorded matter which is excellent in recording stability and the friction resistance of which hardly deteriorates even at the time of high-temperature recording. In addition, the melting point thereof can be measured by a differential scanning calorimeter (DSC). Further, the melting point of the wax particles, for example, can be controlled by adjusting the ratio of a plurality of constitutional units constituting the wax particles.

The wax particles include polyethylene wax particles. Examples of the polyethylene wax particles having a melting point of higher than or equal to 70° C. and lower than 110° C. include, but are not limited to, AQUACER593 polyolefin wax (manufactured by BYK Corporation), Nopcoat PEM-17 (manufactured by San Nopco Limited), Poriron L787 and Poriron L788 (all are manufactured by Chukyo Yushi Co., Ltd.), and Chemipearl W4005 (manufactured by Mitsui Chemicals, Inc.). These polyethylene wax particles having a melting point of higher than or equal to 70° C. and lower than 110° C. may be synthesized by a general method.

The wax particles may be used alone or in a combination of two or more thereof.

The additive amount of the wax particles in the ink composition is preferably 0.1 mass % to 2.5 mass %, and more preferably 0.2 mass % to 2.0 mass % as a solid wax, based on the total mass of the ink composition. When the additive amount thereof is within the above range, recording stability becomes more excellent, and friction resistance hardly deteriorates even at the time of high-temperature recording.

The average particle diameter of the wax particles is preferably 0.02 μm to 0.5 μm, and more preferably 0.04 μm to 0.3 μm. When the average particle diameter thereof is within the above range, recording stability becomes more excellent, and friction resistance hardly deteriorates even at the time of high-temperature recording. In addition, the average particle diameter thereof can be measured in the same method as described for the polymer particles.

### Organic Solvent

The ink composition of the present embodiment may include various organic solvents. Preferably, the ink composition of the present embodiment includes an alkyl polyol having a normal boiling point of higher than or equal to 160° C. and lower than or equal to 260° C. and a Hansen method-based solubility parameter (SP) value of greater than or equal to 10 (cal/cm³)^{1/2} and less than or equal to 15 (cal/cm³)^{1/2}. The organic solvent having a normal boiling point of 160° C. to 260° C. is evaporated by heating on an ink-non-absorptive or ink-low-absorptive recording medium, thereby fixing ink onto the recording medium.

The alkyl polyol satisfying the above-mentioned requirements is not particularly limited, but examples thereof include propylene glycol, 1,3-propanediol, 1,2-butanediol, 1,3-butanediol, 1,4-butanediol, 1,2-pentanediol, 1,5-pentanediol, 1,2-hexanediol, and 1,6-hexane diol. Among these, alkyl polyols of 5 or less carbon atoms, for example, 1,2-butanediol and 1,3-butanediol are particularly preferable. The alkyl polyol of 5 or less carbon atoms is strongly hydrophobic. Therefore, the alkyl polyol can exist stably even in a state in which water is evaporated by the heating of the recording head to make the concentration of the organic solvent higher, and thus it is possible to suppress short-term clogging and improve intermittent ejection properties.

The content rate of the alkyl polyol having an SP value of greater than or equal to 10 (cal/cm³)^{1/2} and less than or equal to 15 (cal/cm³)^{1/2} is more than or equal to 1 mass % and less than or equal to 30 mass %, and more preferably more than or equal to 2 mass % and less than or equal to 20 mass %. When the SP value of the alkyl polyol is within the range of greater than or equal to 10 (cal/cm³)^{1/2} and less than or equal to 15 (cal/cm³)^{1/2}, the compatibility with the polymer particles having a hydrophilic functional group on the outside is good, thereby improving the dispersion of the polymer particles. In particular, the compatibility with the polymer particles provided with a carboxyl group is good. Therefore, it is possible to improve the intermittent ejection performance and prevent the missing of dots.

Here, a solubility parameter (SP value) is described. In the present specification, the SP value refers to an SP value based on the Hansen method. In the Hansen method, the SP value is calculated by classifying SP values δ into three terms δ_{d}, δₚ, and δₕ and representing these terms by the Equation δ²=δ_{d}2+δₚ²+δₕ². δ_{d}, δₚ, and δₕ are solubility parameters corresponding to a dispersion force term, a dipole-dipole force term, and a hydrogen bonding force term, respectively. The SP values of respective solvents based on the Hansen method are described in Table 1 below.

TABLE 1

| | Hansen SP value (cal/cm³)^{1/2} |
|---|---|
| Water | 23.9 |
| Triethylamine | 18.33 |
| Glycerin | 18.08 |
| Trimethyl phosphate | 16.74 |
| Ethylene glycol | 16.48 |
| Polyethylene glycol | 15.11 |
| Methanol | 14.84 |
| 1,3-butanediol | 14.47 |
| Diethylene glycol | 14.21 |
| 2-pyrrolidinone | 14.2 |
| Triethylene glycol | 13.77 |
| 1,2-butanediol | 13.46 |
| Dimethyl sulfoxide | 13.34 |
| Tripropanolamine | 13.21 |
| 1,6-hexanediol | 13.19 |
| 3-methyl-1,3-butanediol | 13.12 |
| Dipropylene glycol | 12.89 |
| Ethanol | 12.73 |
| Tetraethylene glycol | 12.56 |
| Nitromethane | 12.54 |
| 1,2-hexanediol | 12.48 |
| Dimethylformamide | 12.43 |
| 1-(2-hydroxyethyl)-2-pyrrolidone | 12.04 |
| 2-propanol | 11.79 |
| 2-ethyl-1,3-hexanediol | 11.59 |

The content of the above-mentioned alkyl polyol is not particularly limited, but is preferably 5.0 mass % to 35 mass %, and more preferably 5 mass % to 20 mass %, based on the total mass of the ink composition.

### Cyclic Nitrogen Compound and Aprotic Polar Solvent

The ink composition of the present embodiment may further include at least one of a cyclic nitrogen compound and an aprotic polar solvent. When the ink composition includes a cyclic nitrogen compound or an aprotic polar solvent, it is possible to shift the apparent glass transition temperature of the polymer particles to a low-temperature region, and it is possible to soften the core polymer and the shell polymer at a temperature lower than the original temperature, thereby improving the fixability of the ink composition onto the recording medium. Thus, in particular, when the recording medium is made of polyvinyl chloride, it is possible to improve the fixability of the ink composition onto the recording medium.

The aprotic polar solvent is not particularly limited, but examples thereof include a cyclic ketone compound, a chain ketone compound, and a chain nitrogen compound. Typical examples of the cyclic nitrogen compound and the aprotic polar solvent include a pyrrolidone-based solvent, an imidazolidinone-based solvent, a sulfoxide-based solvent, a lactone-based solvent, and an amide ether-based solvent. Among these, 2-pyrrolidone, N-alkyl-2-pyrrolidone, 1-alkyl-2-pyrrolidone, γ-butyrolactone, 1,3-dimethyl-2-imidazolidinone, dimethyl sulfoxide, imidazole, 1-methylimidazole, 2-methylimidazole, 1,2-dimethyl imidazole, and alkoxy propionamide are preferable.

The content of the cyclic nitrogen compound and the aprotic polar solvent is not particularly limited, but is preferably 5.0 mass % to 35 mass %, and more preferably 5 mass % to 20 mass %, based on the total amount of the ink composition.

### Other Solvents

The ink of the present embodiment may further include other solvents except for the above-mentioned solvents. The other solvents except for the above-mentioned solvents are not particularly limited, but specific examples thereof include alcohols and glycols, such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, methanol, ethanol, n-propyl alcohol, iso-propyl alcohol, n-butanol, 2-butanol, tert-butanol, iso-butanol, n-pentanol, 2-pentanol, 3-pentanol, and tert-pentanol. These other solvents may be used alone or in a combination of two or more thereof.

The boiling point of each of the other solvents is preferably 140° C. to 280° C., more preferably 160° C. to 260° C., and still more preferably 180° C. to 240° C. When the boiling point of each of the other solvents is within the above range, intermittent characteristics tend to be improved.

The content of each of the other solvents is preferably 5.0 mass % to 25 mass %, and more preferably 10 mass % to 20 mass %, based on the total amount of the ink composition.

Alkyl Polyol Having a Normal Boiling Point of Higher than or Equal to 280° C.

It is preferable that the ink composition of the present embodiment does not substantially contain an alkyl polyol having a normal boiling point of higher than or equal to 280° C. Here, “does not substantially contain” means a degree of adding no more than an amount needed to fully achieve the significance of adding a predetermined component. The content of the alkyl polyol having a normal boiling point of higher than or equal to 280° C. in the ink composition is preferably more than or equal to 0 mass % and less than 1.0 mass %, more preferably more than or equal to 0 mass % and less than 0.5 mass %, still more preferably more than or equal to 0 mass % and less than 0.1 mass %, still more preferably more than or equal to 0 mass % and less than 0.05 mass %, still more preferably more than or equal to 0 mass % and less than 0.01 mass %, and most preferably more than or equal to 0 mass % and less than 0.001 mass %, based on the total mass of the ink composition. When the content thereof is within the above range, the friction resistance of the recorded matter using the ink composition being deteriorated by the alkyl polyol having a normal boiling point of higher than or equal to 280° C. is suppressed, and thus it is possible to obtain recorded matter having more excellent friction resistance.

### Surfactant

It is preferable that the ink composition used in the present embodiment contains a surfactant. The surfactant is not particularly limited, but examples thereof include an acetylene glycol-based surfactant, a fluorine-based surfactant, and a silicone-based surfactant. When the ink composition contains these surfactants, the dryness of the ink composition deposited to the recording medium becomes better, and high-speed printing can be conducted.

Among these, a silicone-based surfactant is more preferable because the solubility thereof in the ink composition increases to reduce the generation of foreign matter.

The acetylene glycol-based surfactant is not particularly limited, but, for example, is preferably one or more selected from alkylene oxide adducts of 2,4,7,9-tetramethyl-5-decyne-4,7-diol and 2,4,7,9-tetramethyl-5-decyne-4,7-diol; and alkylene oxide adducts of 2,4-dimethyl-5-decyne-4-ol and 2,4-dimethyl-5-decyne-4-ol. Commercially available products of the acetylene glycol-based surfactant are not particularly limited, but examples thereof include E series such as Olfine 104 series and Olfine E1010 (all are trade names, manufactured by Air Products Japan, Inc.), and Surfynol 465, Surfynol DF110D, and Surfynol 61 (all are trade names, manufactured by Nissin Chemical Industry Co., Ltd.). These acetylene glycol-based surfactants may be used alone or in a combination of two or more thereof.

The fluorine-based surfactant is not particularly limited, but examples thereof include perfluoroalkyl sulfonates, perfluoroalkyl carboxylates, perfluoroalkyl phosphate esters, perfluoroalkyl ethylene oxide adducts, perfluoroalkyl betaine, and perfluoroalkyl amine oxide compounds. Commercially available products of the fluorine-based surfactant are not particularly limited, but examples thereof include S-144 and S-145 (manufactured by Asahi Glass Co., Ltd.); FC-170C, FC-430, and Florad-FC4430 (manufactured by Sumitomo 3M Co., Ltd.); FSO, FSO-100, FSN, FSN-100, and FS-300 (manufactured by Dupont Inc.); and FT-250 and FT-251 (manufactured by Neos Co., Ltd.). These fluorine-based surfactants may be used alone or in a combination of two or more thereof.

Examples of the silicone-based surfactant include polysiloxane compounds, polyether-modified organosiloxane, and the like. Commercially available products of the silicone-based surfactant are not particularly limited, but specific examples thereof include BYK-306, BYK-307, BYK-333, BYK-341, BYK-345, BYK-346, BYK-347, BYK-348, and BYK-349 (all are trade names, manufactured by BYK Japan KK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all are trade names, manufactured by Shin-Etsu chemical Co., Ltd.).

The content of the surfactant is preferably 0.1 mass % to 5 mass %, and more preferably 0.1 mass % to 3.0 mass %, based on the total amount of the ink composition. When the content of the surfactant is within the above range, the wettability of the ink composition deposited to the recording medium tends to be further improved.

### pH Adjuster

The ink of the present embodiment may contain a pH adjuster. Examples of the pH adjuster include inorganic alkaline compounds such as sodium hydroxide, potassium hydroxide, and the like, ammonia, diethanolamine, triethanolamine, triisopropanolamine, morpholine, potassium dihydrogen phosphate, disodium hydrogen phosphate, and sodium ethylenediamine tetraacetate.

The pH adjusters may be used alone or in a combination of two or more thereof. The content of the pH adjuster is not particularly limited, and may be appropriately determined as necessary.

### Other Components

The ink of the present embodiment may be appropriately added with various additives, such as a dissolution aid, a viscosity modifier, an antioxidant, a preservative, a fungicide, a defoamer, a corrosion inhibitor, and the like, in addition to the above components.

It is preferable that the ink composition of the present embodiment is recorded on a heated recording medium. When the above-mentioned heated recording medium is used, it is possible to form an image having excellent friction resistance. In addition, in the case where the recording medium is heated, a head is warmed by radiant heat thereof. According to the ink composition of the present embodiment, even when the head is warmed, the clogging of nozzles can be suppressed, and the ejection stability of the ink composition can be improved. The heating temperature is preferably higher than or equal to 35° C., more preferably higher than or equal to 40° C. and lower than or equal to 110° C., and still more preferably higher than or equal to 45° C. and lower than or equal to 120° C.

In order to heat the recording medium, for example, a platen heater or infrared radiation is used. In addition, it is preferable that the ink composition of the present embodiment is an ink composition used in an ink jet recording method from the viewpoint of more effectively and reliably exhibiting the actions and effects of the invention.

### Production Method of Ink

The ink of the present embodiment can be obtained by mixing the above-mentioned components in any order and filtering the mixture if necessary to remove impurities. Here, it is preferable in terms of convenience of handling that pigment is previously prepared in a state of being uniformly dispersed in a solvent, and is then mixed with other components.

As the method of mixing the components, methods of sequentially putting the components into a container equipped with a stirring device such as a mechanical stirrer or a magnetic stirrer and then stirring and mixing these components are preferably used. As a filtration method, for example, centrifugal filtration, filtration using a filter, or the like may be conducted, if necessary.

### Recording Medium

The recording medium is an absorptive, low-absorptive, or non-absorptive recording medium. As the recording medium, a low-absorptive or non-absorptive recording medium is preferable, and a non-absorptive recording medium is more preferable. It is preferable that a heated recording medium is used as the recording medium. When recording is performed by depositing the ink composition of the present embodiment onto the heated recording medium, the shell polymer is softened at the time of depositing the ink composition onto the recording medium, and thus a film having excellent friction resistance can be formed. Since the recording medium may be heated, it is not necessary to heat a nozzle more than necessary in order to lower the viscosity of the ink composition. Therefore, it is possible to suppress the deposition of components such as resin and the like in the ink composition onto the inner wall of a nozzle, and clogging recovery properties become excellent. The surface temperature of the recording medium at the time of heating is preferably 30° C. to 60° C., and more preferably 40° C. to 60° C.

The absorptive recording medium is not particularly limited, but is particularly preferably a high-absorption recording medium such as a fabric. Examples of the fabric include, but are not limited to, natural fibers or synthetic fibers such as silk, cotton, wool, nylon, polyester, rayon, and the like.

The low-absorptive recording medium is not particularly limited, but an example thereof includes coated paper in which a coating layer for receiving an oil-based ink composition is provided on the surface. The coated paper is not particularly limited, but examples thereof include printing papers such as art paper, coat paper, and matte paper.

The non-absorptive recording medium is not particularly limited, but examples thereof include a film or plate made of plastics such as polyvinyl chloride, polyethylene, polypropylene, and polyethylene terephthalate (PET); a plate made of metals such as iron, silver, copper, and aluminum; a metal plate or a plastic-made film fabricated by the deposition of these various metals; a plate made of an alloy of stainless steel or brass; and the like. In addition, it is preferable that the non-absorptive recording medium have neither an ink absorbing layer composed of silica particles or alumina particles nor an ink absorbing layer composed of a hydrophilic polymer such as polyvinyl alcohol (PVA), polyvinyl pyrrolidone (PVP), or the like.

Here, the “low-absorptive recording medium” and “non-absorptive recording medium” may be a recording medium having an amount of water absorption of less than or equal to 10 mL/m² from the start of contact until 30 msec in Bristow's method. This Bristow's method is the most common method as a method of measuring the amount of liquid absorption in a short period of time and is also employed in Japan Technical Association of the Pulp and Paper Industry (JAPAN TAPPI). The details of the test method are described in Standard No. 51, “Paper and Paperboard—Liquid Absorption Test Method—Bristow's method” of “JAPAN TAPPI Paper Pulp Test Methods, 2000 version”.

In addition, the non-absorptive recording medium or the low-absorptive recording medium can also be classified in accordance with wettability of water on a recording surface. For example, the recording medium can be characterized by dripping 0.5 μL of a water droplet onto the recording surface of the recording medium to measure the reduction rate of a contact angle (comparing a contact angle at 0.5 msec after impact to a contact angle at 5 sec after the impact). More specifically, as characteristics of the recording medium, the non-absorbency of the “non-absorptive recording medium” indicates that the above-described reduction rate is lower than 1% and the low-absorbency of the “low-absorptive recording medium” indicates that the reduction rate is higher than or equal to 1% and lower than 5%. In addition, the absorbency indicates that the above-described reduction rate is higher than or equal to 5%. It is possible to measure the contact angle using Portable Contact Angle Meter PCA-1 (manufactured by Kyowa Interface Science Co., Ltd.) or the like.

### Recording Method

The recording method of the present embodiment includes a heating process of heating a recording medium and an ejecting process of ejecting the ink composition from a nozzle and depositing the ejected ink composition onto the recording medium.

### Heating Process

The heating process is a process of heating a non-absorptive recording medium or a low-absorptive recording medium. The heating process can be performed by an IR heater or a platen heater. When the non-absorptive recording medium or the low-absorptive recording medium is heated, the shell polymer of the polymer particle deposited on the recording medium is easily softened, and thus recorded matter having excellent friction resistance can be obtained. The surface temperature of the recording medium is preferably higher than or equal to 65° C., more preferably higher than or equal to 70° C., and still more preferably higher than or equal to 70° C. and lower than or equal to 110° C.

### Ejecting Process

The ejecting process is a process of ejecting the ink composition from a nozzle and depositing the ejected ink composition onto the recording medium. As the ejection unit (recording head) of the ink composition, an ejection unit known in the related art may be used. As an example of the ejection unit known in the related art, there is an ejection unit for ejecting liquid droplets using the vibration of a piezoelectric element, that is, an ejection unit for forming ink droplets by mechanical deformation of an electrostrictive element.

Due to the heating process and the ejecting process, the shell polymer of the polymer particles of the ink composition in the recording head is not softened, and the deposition of the polymer particles into the recording head can be suppressed, thereby improving ejection stability.

### Drying Process

The recording method of the present embodiment may include a drying process of drying the ink composition. The drying unit is not particularly limited, but examples thereof include a heater, a hot air mechanism (not shown), and a thermostatic bath (not shown). When the drying unit heats the recording medium on which an image is recorded, moisture or the like contained in the ink composition is more rapidly volatilized and scattered, and thus a film is formed by the polymer particles contained in the ink composition. In this way, dried ink matter is strongly fixed (deposited) on the recording medium, and thus a high-quality image having excellent friction resistance can be obtained in a short time.

### Recording Apparatus

The recording apparatus according to the present embodiment includes a recording head for ejecting the ink composition onto a recording medium; a heating unit for heating the recording medium; and a drying unit for drying the ink composition for an ink jet deposited to the recording medium. This recording apparatus may further have the above-mentioned ink composition for an ink jet.

FIGURE is a schematic cross-sectional view of a recording apparatus according to the present embodiment. As shown in FIGURE, the recording apparatus 1 includes a recording head 2, an IR heater 3, a platen heater 4, a curing heater 5, a cooling fan 6, a preheater 7, and a ventilation fan 8.

The recording head 2 ejects the ink composition onto the recording medium. As the recording head 2, a recording head known in the related art may be used. As an example of the known recording head in the related art, there is a recording head for ejecting liquid droplets using the vibration of a piezoelectric element, that is, a recording head for forming ink droplets by mechanical deformation of an electrostrictive element.

The recording medium heating unit serves to heat the recording medium at the time of ejecting the ink composition from the recording head 2. The recording medium heating unit is not particularly limited, but examples thereof include a unit for directly heating the recording head 2 by hot air or the IR heater 3 and a unit for heating the recording head 2 through the recording medium heated by the platen heater 4.

In addition, when the IR heater 3 is used, the recording medium can be heated from the side of the recording head 2. Therefore, the recording head 2 is also heated simultaneously, but the temperature of the recording medium can be increased without being affected by the thickness of the recording medium, compared to when the recording medium is heated from the back side thereof by the platen heater 4 or the like. Further, when the platen heater 4 is used, the recording medium can be heated from the side opposite to the side of the recording head 2. Thus, the recording head 2 becomes relatively difficult to heat.

Preferably, at the time of ejecting the ink composition onto the recording medium, the recording apparatus 1 further includes a recording medium heating unit for heating a recording medium such that the surface temperature of the recording medium is higher than or equal to 35° C. More preferably, the surface temperature thereof is higher than or equal to 30° C. and lower than or equal to 60° C. The recording medium heating unit is not particularly limited, but examples thereof include the IR heater 3 and a platen heater 4. When the recording apparatus 1 includes the recording medium heating unit, the ink composition deposited to the recording medium can be rapidly dried, and bleeding can be further suppressed.

The drying unit serves to heat and dry the recording medium coated with the ink composition for an ink jet. The drying unit is not particularly limited, but examples thereof include the curing heater 5, a hot air mechanism (not shown), and a thermostatic bath (not shown). When the drying unit heats the recording medium on which an image is recorded, moisture or the like contained in the ink composition is more rapidly volatilized and scattered, and thus a film is formed by the polymer particles contained in the ink composition. In this way, dried ink matter is strongly fixed (deposited) on the recording medium, and thus a high-quality image having excellent friction resistance can be obtained in a short time. The temperature of the drying unit is preferably higher than that of the recording medium heating unit, more preferably higher than or equal to 70° C., and still more preferably higher than or equal to 70° C. and lower than or equal to 110° C.

In addition, the above described “heating the recording medium” refers to raising the temperature of the recording medium to a desired temperature, and is not limited to directly heating the recording medium.

The recording apparatus 1 may have the cooling fan 6. When the ink composition on the recording medium is cooled by the cooling fan 6 after the drying, a film having excellent adhesivity can be formed on the recording medium.

In addition, the recording apparatus 1 may include the preheater 7 for previously heating (preheating) the recording medium before the ejection of the ink composition onto the recording medium. Further, the recording apparatus may include the ventilation fan 8 for more efficiently drying the ink composition deposited to the recording medium.

### Example 1

Hereinafter, Examples of the above-mentioned ink composition according to the invention will be described in detail, but the invention is not limited thereto.

### Preparation of Aqueous Core-Shell Polymer Particle Dispersion

100 parts of ion exchange water was put into a reactor equipped with a dropping device, a thermometer, a water-cooling reflux condenser, and a stirrer, and 0.2 parts of ammonium persulfate as a polymerization initiator was added under a nitrogen atmosphere of 70° C. with stirring, and then a monomer solution containing 42 parts of styrene, 21 parts of methyl methacrylate, and 7 parts of acrylic acid was dropped into the reactor to prepare a shell polymer by a polymerization reaction. Thereafter, a mixed solution of 0.2 parts of potassium persulfate, 22 parts of styrene, and 8 parts of n-butyl acrylate was dropped and polymerized with stirring at 70° C., and then the resultant product was neutralized with sodium hydroxide to adjust pH to 8 to 8.5, and filtered by a filter of 0.3 μm to prepare an aqueous core-shell polymer particle dispersion (polymer particle A).

As shown in Table 2 below, polymer particles B to H were prepared in the same manner as polymer particle A, except for changing the ratio of components constituting the shell and the core.

The differential scanning calorimetry (DSC) of the obtained core-shell polymer particles was carried out based on JIS K7121 to obtain the glass transition temperature Tg (° C.) of each of a polymer constituting the core polymer and a polymer constituting the shell polymer. The model “DSC6220”, manufactured by Seiko Electronics Industrial Co., Ltd., was used as a differential scanning calorimeter.

In addition, the obtained core-shell polymer particles were measured by Microtrac UPA (manufactured by Nikkiso Co., Ltd.) to obtain the particle diameters φ (nm) of the core-shell polymer particles.

Further, the polymer particles were measured by AT 610 (manufactured by Kyoto Electronics Manufacturing Co., Ltd.), and numerical values were fitted in Equation (1) below to calculate an acid value.

Acid value(mg/g)=(EP1−BL1)×FA1×C1×K1/SIZE (1)

In the Equation, EP1 indicates a titer (mL), BL1 indicates a blank value (0.0 mL), FA1 indicates a titrant factor (1.00), C1 indicates a concentration conversion value (5.611 mg/mL) (1 mL of potassium hydroxide equivalent of 0.1 mol/L KOH), K1 indicates a coefficient (1), and SIZE indicates a sampling amount (g), respectively.

In Table 2 below, acids values of polymer particles A to H, Tg of core polymer, Tg of shell polymer, and ratios of aromatic ring monomer to carboxylic acid in shell polymer (aromatic ring monomer/carboxylic acid) are summarized.

TABLE 2

| | | Polymer | Polymer | Polymer | Polymer | Polymer | Polymer | Polymer | Polymer |
|---|---|---|---|---|---|---|---|---|---|
| | | particle | particle | particle | particle | particle | particle | particle | particle |
| | | A | B | C | D | E | F | G | H |
| Shell | Styrene | 42 | 28 | 28 | 25 | 7 | 7 | 28 | 0 |
| | Methyl | 21 | 35 | 40 | 35 | 56 | 56 | 38.5 | 63 |
| | methacrylate | | | | | | | | |
| | Acrylic acid | 7 | 7 | 7 | 10 | 7 | 7 | 3 | 7 |
| Core | Styrene | 22 | 22 | 10 | 12 | 12 | 22 | 22 | 12 |
| | Butyl acrylate | 8 | 8 | 15 | 18 | 18 | 8 | 8 | 18 |
| Characteristics | Acid value | 90 | 90 | 90 | 120 | 90 | 90 | 30 | 90 |
| | Tg of shell | 101 | 85 | 72 | 67 | 62 | 64 | 71 | 45 |
| | Tg of core | 54 | 56 | 33 | −10 | −8 | 56 | 56 | 52 |
| | Aromatic ring | 0.17 | 0.25 | 0.25 | 0.40 | 1.00 | 1.00 | 0.11 | — |
| | monomer/carboxylic | | | | | | | | |
| | acid monomer of | | | | | | | | |
| | shell | | | | | | | | |

### Preparation of Ink Composition

Raw materials were respectively mixed in the composition ratios (mass %) shown in Table 3 below, and sufficiently stirred to obtain the ink compositions of Examples 1 to 8 and Comparative Examples 1 to 3.

TABLE 3

| | | | | | | | | | | Comp. | Comp. | Comp. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 | Ex. 3 |
| | | Ink 1 | Ink 2 | Ink 3 | Ink 4 | Ink 5 | Ink 6 | Ink 7 | Ink 8 | Ink 9 | Ink 10 | Ink 11 |
| Pigment | C.I pigment blue 15:3 | 2 | 2 | 2 | 2 | 2 | 2 | 2 | 2 | 2 | 2 | 2 |
| Solvent | 1,3-butanediol | 10 | 10 | 10 | 10 | 10 | 10 | | | 10 | 10 | 10 |
| | 1,2-butanediol | | | | | | | | 10 | | | |
| | 1,2-hexanediol | | | | | | | 10 | | | | |
| | 2-pyrrolidone | 10 | 10 | 10 | 10 | 10 | 10 | 10 | 10 | 10 | 10 | 10 |
| Surfactant | BYK348 | 0.4 | 0.4 | 0.4 | 0.4 | 0.4 | 0.4 | 0.4 | 0.4 | 0.4 | 0.4 | 0.4 |
| | Surfynol DF110D | 0.3 | 0.3 | 0.3 | 0.3 | 0.3 | 0.3 | 0.3 | 0.3 | 0.3 | 0.3 | 0.3 |
| Polymer | Polymer particle A | 3 | | | | | | | | | | |
| particles | Polymer particle B | | 3 | | | | | | | | | |
| | Polymer particle C | | | 3 | | | | | | | | |
| | Polymer particle D | | | | 3 | | | | | | | |
| | Polymer particle E | | | | | 3 | | | | | | |
| | Polymer particle F | | | | | | 3 | | | | | |
| | Polymer particle G | | | | | | | | | | 3 | |
| | Polymer particle H | | | | | | | | | | | 3 |
| Resin | JonCryl7100, aqueous styrene/acryl | | | | | | | | | 3 | | |
| emulsion | emulsion resin manufactured by | | | | | | | | | | | |
| | BASF Corporation (solid content: | | | | | | | | | | | |
| | 48%, Tg: −10° C., acid value: 51) | | | | | | | | | | | |
| | JonCryl7610, styrene/acryl resin | | | | | | | | | | | |
| | manufactured by BASF Corporation | | | | | | | | | | | |
| | (Tg: 96° C., lowest film forming | | | | | | | | | | | |
| | temperature: 63° C., solid content: 52%) | | | | | | | | | | | |
| Wax | AQUACER593 polyolefin wax, | 1.5 | 1.5 | 1.5 | 1.5 | 1.5 | 1.5 | 1.5 | 1.5 | 1.5 | 1.5 | 1.5 |
| particle | manufactured by BYK Corporation | | | | | | | | | | | |
| pH | Triethanolamine | 0.5 | 0.5 | 0.5 | 0.5 | 0.5 | 0.5 | 0.5 | 0.5 | 0.5 | 0.5 | 0.5 |
| adjuster | Sodium ethylenediamine tetraacetate | 0.3 | 0.3 | 0.3 | 0.3 | 0.3 | 0.3 | 0.3 | 0.3 | 0.3 | 0.3 | 0.3 |
| Water | | bal- | bal- | bal- | bal- | bal- | bal- | bal- | bal- | bal- | bal- | bal- |
| | | ance | ance | ance | ance | ance | ance | ance | ance | ance | ance | ance |
| Intermittent | Short-term clogging properties | A | A | A | A | C | C | B | B | A | B | D |
| ejection | Long-term clogging properties (room | A | B | B | A | B | B | A | B | C | D | B |
| | temperature) | | | | | | | | | | | |
| D missing | Long-term clogging properties | B | B | B | B | B | B | B | B | C | D | B |
| ejection | (50° C.) | | | | | | | | | | | |
| | Friction resistance | A | A | A | A | A | A | A | A | B | A | A |
| | Wet friction | A | A | A | B | A | A | A | A | B | A | A |
| | Aggregation unevenness | A | A | B | B | C | C | C | C | C | B | B |

### Evaluation Method

### (1) Short-Term Clogging Properties

An ink jet printer (trade name: PX-H8000, manufactured by Seiko Epson Corporation) was filled with the ink composition, and was left for 5 minutes with a cap open. In addition, this evaluation was performed in a laboratory under a condition of 50° C. Thereafter, nozzles were checked, and it was determined how many nozzles were missing. Evaluation criteria are as follows. The evaluation results thereof are shown in Table 3 above.

### Evaluation Criteria

A: No missing nozzle
B: 1 to 5 missing nozzles
C: 6 to 20 missing nozzles
D: more than or equal to 21 missing nozzles

### (2) Long-Term Clogging Properties

An ink jet printer (trade name: PX-H8000, manufactured by Seiko Epson Corporation) was filled with the ink composition, and was left for 1 month with a cap open. Thereafter, cleaning was performed three times, and it was determined how many nozzles were missing. Evaluation criteria are as follows. The evaluation results thereof are shown in Table 3 above.

### Evaluation Criteria

A: No missing nozzle
B: 1 to 5 missing nozzles
C: 6 to 20 missing nozzles
D: More than or equal to 21 missing nozzles

### (3) Friction Resistance

An ink jet printer (trade name: PX-G930, manufactured by Seiko Epson Corporation) was filled with the ink composition, and recording was performed on a recording medium (clear-proof film, manufactured by Seiko Epson Corporation). Specifically, a fill pattern that can be recorded with 100% duty at a resolution of horizontal 720 dpi×vertical 720 dpi was prepared and then used. In this case, the surface temperature of the recording medium was set to 50° C. In addition, this evaluation was performed in a laboratory under a condition of room temperature (25° C.) Thereafter, the recorded surface of the recorded matter left in the laboratory under a condition of room temperature (25° C.) for 1 hour was rubbed 20 times with a cotton cloth under a load of 200 g using color fastness rubbing tester AB-301 (manufactured by TESTER Sangyo Co., Ltd.), and then the stripped state of the recorded surface or the transfer state of ink to the cotton cloth was observed, thereby evaluating friction resistance. Evaluation criteria are as follows. The evaluation results thereof are shown in Table 3 above.

### Evaluation Criteria

A: Ink stripping or ink transfer to cotton cloth was not observed even after rubbing was performed 20 times.
B: Ink stripping or ink transfer to cotton cloth was observed after rubbing was performed 11 to 15 times.
C: Ink stripping or ink transfer to cotton cloth was observed after rubbing was performed 6 to 10 times.
D: Ink stripping or ink transfer to cotton cloth was observed after rubbing was performed 1 to 5 times.

### (4) Wet Friction (Water Friction Resistance)

An ink jet printer (trade name: PX-G930, manufactured by Seiko Epson Corporation) was filled with the ink composition, and recording was performed on a recording medium (clear-proof film, manufactured by Seiko Epson Corporation). Specifically, a fill pattern that can be recorded with 100% duty at a resolution of horizontal 720 dpi×vertical 720 dpi was fabricated and then used. In this case, the surface temperature of the recording medium was set to 50° C. In addition, this evaluation was performed in a laboratory under a condition of room temperature (25° C.) Thereafter, the recorded surface of the recorded matter left in the laboratory under a condition of room temperature (25° C.) for 1 hour was rubbed 20 times with a cotton cloth immersed in water for 5 seconds under a load of 200 g using color fastness rubbing tester AB-301 (TESTER, manufactured by Sangyo Co., Ltd.), and then the stripped state of the recorded surface or the transfer state of ink to the cotton cloth was observed, thereby evaluating wet friction. Evaluation criteria are as follows. The evaluation results thereof are shown in Table 3 above.

### Evaluation Criteria

A: Ink stripping or ink transfer to cotton cloth was not observed even after rubbing was performed 20 times.
B: Ink stripping or ink transfer to cotton cloth was observed after rubbing was performed 11˜15 times.
C: Ink stripping or ink transfer to cotton cloth was observed after rubbing was performed 6˜10 times.
D: Ink stripping or ink transfer to cotton cloth was observed after rubbing was performed 1˜5 times.

### (5) Aggregation Unevenness

For evaluation of aggregation unevenness, the same recorded matter as that used in the above frictional resistance test was used. The aggregation unevenness of ink in the solid pattern of the recorded matter was visually observed, and was evaluated by the following evaluation criteria. In addition, this evaluation was performed in a laboratory under a condition of room temperature (25° C.). Evaluation criteria are as follows. The evaluation results thereof are shown in Table 3 above.

### Evaluation Criteria

A: Aggregation unevenness was not observed in the solid pattern.
B: Aggregation unevenness was slightly observed in the solid pattern.
C: Aggregation unevenness was remarkably observed overall in the solid pattern.

As described above, it can be seen that the ink compositions of Examples 1 to 9 are excellent in friction resistance and wet friction. In addition, it can be seen that the ink compositions of Examples 1 to 9 are excellent in short-term clogging properties and long-term clogging properties (at normal temperature), and thus excellent in intermittent ejection performance. Moreover, it can be seen that the ink compositions of Examples 1 to 9 are excellent in long-term clogging properties (at 50° C.), and thus excellent in prevention performance of dot missing.

Among the ink compositions of Examples 1 to 9, it can be seen that the short-term clogging properties of the ink compositions of Examples 1 to 4, in each of which polymer particles A to D having a ratio of aromatic ring monomer to carboxylic acid monomer of shell of greater than or equal to 0.15 are used, can be further improved compared to that of the ink compositions of Examples 5 to 8, in each of which polymer particles E to F having a ratio of aromatic ring monomer to carboxylic acid monomer of less than 0.15 are used, and thus the intermittent ejection performance thereof is excellent. That is, it can be seen that the ink compositions, in each of which polymer particles A to D having a ratio of aromatic ring monomer to carboxylic acid monomer of shell of greater than or equal to 0.15 are used, are excellent in the balance of friction resistance and re-dispersibility.

The entire disclosure of Japanese Patent Application No. 2014-046869, filed Mar. 10, 2014 is expressly incorporated by reference herein.

What is claimed is:

1. An ink composition, comprising:
a color material;
water; and
a polymer particle,
wherein the polymer particle has a core-shell structure including a core polymer and a shell polymer,
wherein the core polymer has a glass transition temperature of lower than 60° C., and the shell polymer has a glass transition temperature of higher than or equal to 60° C.,
wherein the polymer particle has an acid value of greater than or equal to 50 mgKOH/g, and
wherein the shell polymer includes an aromatic monomer as a constitutional unit.

2. The ink composition according to claim 1, which is recorded on a heated recording medium.

3. The ink composition according to claim 1,
wherein the core polymer includes an aromatic monomer as a constitutional unit, and
wherein the core polymer does not have an acid value.

4. The ink composition according to claim 1,
wherein the polymer particle is synthesized without substantially using an emulsifier.

5. The ink composition according to claim 1,
wherein the polymer particle includes an aromatic monomer in an amount of greater than or equal to 10 mass % and less than or equal to 80 mass % as a constitutional unit.

6. The ink composition according to claim 1, further comprising a wax particle having a melting point of higher than or equal to 70° C. and lower than or equal to 110° C.

7. The ink composition according to claim 1, further comprising an alkyl polyol having a normal boiling point of higher than or equal to 160° C. and lower than or equal to 260° C. and a Hansen solubility parameter (SP) value of greater than or equal to 10 (cal/cm³)^{1/2} and less than or equal to 15 (cal/cm³)^{1/2}.

8. The ink composition according to claim 1,
wherein the polymer particle has an average particle diameter of greater than or equal to 10 nm and less than or equal to 100 nm.

9. The ink composition according to claim 1,
wherein the shell polymer further includes a carboxylic acid monomer as a constitutional unit, and a ratio of the aromatic monomer to the carboxylic acid monomer (aromatic monomer/carboxylic acid monomer) is greater than or equal to 0.15.
